(19) United States
(12) Patent Application Publication
(10) Pub. No.: US 2010/0179839 A1
(43) Pub. Date: Jul. 15, 2010

(54) SYSTEM AND METHOD FOR PROVIDING AN INSURANCE PRODUCT THAT REIMBURSES A POLICY HOLDER FOR THE COST OF HEALTH INSURANCE ADMINISTERED UNDER COBRA

(76) Inventors: Richard A. Collins, Indianapolis, IN (US); Steve L. Pollack, Westfield, IN (US); Darrell S. Richey, Indianapolis, IN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/685,483

(22) Filed: Jan. 11, 2010

Related U.S. Application Data
(60) Provisional application No. 61/143,922, filed on Jan. 12, 2009.

(51) Int. Cl. G06Q 40/00

(52) U.S. Cl. 705/4

(57) ABSTRACT

A system and method for generating and administering an insurance product e.g., an insurance policy and/or rider, via. a computer system, that reimburses a policy holder for the cost of health insurance administered under COBRA, by providing benefits that reimburse a policy holder for all or a portion of a policy holder's COBRA insurance premiums for a period of time. The policy holder may receive health benefits under their original group plan at his or her original employer-sponsored, group health plan rate, and have a portion of the cost reimbursed through the insurance product, or the policy holder may elect to receive individual/family health insurance coverage, where the policy holder is instead reimbursed for all or a portion of the premiums for that coverage for a period of time by the insurance product.

### CROSS REFERENCE TO RELATED APPLICATIONS

This application claims the benefit under 35 U.S.C. §119(e) to U.S. Provisional Patent Application No. 61/143,922 entitled “SYSTEM AND METHOD FOR PROVIDING AN INSURANCE PRODUCT THAT REIMBURSES A POLICY HOLDER FOR THE COST OF HEALTH INSURANCE ADMINISTERED UNDER COBRA,” filed Jan. 12, 2009, the disclosure of which is hereby incorporated by reference.

### FIELD OF THE INVENTION

The present invention relates to a computer implemented system and method for reimbursing a policy holder for all or a portion of the cost of health insurance under circumstances where health insurance would otherwise become more expensive. In particular, the present invention relates to a computer implemented system and method of providing insurance protecting a policy holder from the increased cost of insurance administered under COBRA health benefit provisions.

### BACKGROUND

The Consolidated Omnibus Budget Reconciliation Act (“COBRA”) health benefit provisions make available to former employees, retirees, spouses and dependent children temporary, continued employer-sponsored group health coverage where that coverage may otherwise be terminated. When events occur that would result in an insured no longer qualifying for coverage under an employer-sponsored group health plan, many individuals and/or their family members qualify for continued employer-sponsored group health coverage under the COBRA provisions. The event that most commonly leads to the loss of employer-sponsored group health coverage for a beneficiary includes termination of employment of the employee. Upon the occurrence of one or more of the qualifying events, individuals become eligible for COBRA continuation coverage for a time period ranging from 18 to 36 months depending on the type of qualifying event. Individuals usually elect COBRA Coverage to remain insured while looking for alternative insurance coverage or new employment.

The premium payable by an individual electing COBRA continuation coverage equals both the amount of the employee's former contribution and the amount of the employer's contribution, under the employer-sponsored group health plan. In addition, the plan administrator may charge an individual electing COBRA Coverage up to an additional two percent of the total policy premium to offset any extra administrative costs. Consequently, when a person is unemployed, paying the COBRA Coverage premiums, together with any administrative fee, can present a considerable expense. Furthermore, trends towards reduction of work forces are increasing, and reduced benefits in the workplace are becoming more common. As a result, individuals are becoming more concerned about job lay-offs and the impact to their income and health care options. Accordingly, there is a need to provide relief to individuals who elect, subject to the increased premium and administrative fee, to remain covered by their employer-sponsored group health plan under COBRA.

### SUMMARY

The present invention relates to a computer implemented system and method for generating and administering an insurance product, e.g., an insurance policy or insurance policy plus a rider where, upon the policy holder experiencing a qualifying event such as the involuntary termination of a policy holder's coverage of an employer-sponsored group health insurance or HMO coverage, the insurance company agrees to reimburse the policy holder a certain dollar amount per month (or other billing period), e.g., $500 per month, for the premiums or administrative fee payable by the policy holder to maintain employer-sponsored group health insurance under the provisions of COBRA (“COBRA Coverage”). Any amount of premiums or administrative fee for the COBRA Coverage, in excess of the insurance benefit, is the responsibility of the policy holder. The insurance product may be configured based on factors including: lapse decrements, utilization, underwriting, loss ratios, policy and rider distribution assumptions and current laws. By purchasing the insurance product of the present invention, a policy holder may keep his or her health insurance benefits through the COBRA Coverage, where he or she may otherwise not be able to afford the premiums and administrative fees thereof

One aspect of the present invention is a computer implemented system and method for generating insurance policy product data associated with an insurance policy that provides insurance coverage for at least one individual, comprising a computer processor programmed to perform and performing a retrieval of policy configuration data from an electronic database, the configuration data comprising at least one of the following configuration factors: lapse decrements, utilization, underwriting, loss ratios, policy and rider distribution assumptions and current laws; and programmed to perform and performing retrieval of product enrollment data for an individual to be insured from an electronic database; programmed to generate and generating insurance policy product data based on the product enrollment data and the policy configuration data wherein the insurance policy product data defines terms associated with an insurance policy for providing insurance coverage to the individual, wherein the insurance policy defines a benefit that reimburses the individual for at least a portion of the individual's health insurance premiums while the individual is receiving health coverage after experiencing a qualifying event and an electronic database programmed to store and storing the insurance policy product data, individual product enrollment data and policy configuration data.

Another aspect of the present invention is a computer implemented system for administering an insurance policy that provides insurance coverage for at least one policy holder comprising: an electronic database for storing insurance policy product data wherein the insurance policy product data defines terms associated with an insurance policy for providing insurance coverage to the policy holder, wherein the insurance policy defines a benefit that reimburses the policy holder for at least a portion of the policy holder's health insurance premiums while the policy holder is receiving health coverage after experiencing certain qualifying events; a computer processor programmed to: update payment information in the insurance policy product data in response to a receipt of premium payments; update the insurance policy product data to reflect receipt of a notification of the occurrence of at least one qualifying event that allows a policy holder to qualify for continued coverage under the policy holder's health plan that may trigger coverage under the insurance policy; and update the insurance policy product data in the database to reflect changes in the insurance policy; and generate the periodic reimbursement of a policy holder who has noticed the system of a qualifying event of a portion of the policy holder's health insurance premiums up to a predetermined amount;

These and other features and advantages of aspects of the present invention will become apparent to those skilled in the art from the following detailed description, where it is shown and described in illustrative embodiments, including best modes contemplated for carrying out the invention. As it will be realized, the various aspects of the invention are capable of modifications in various obvious respects, all without departing from the spirit and scope of the present invention. Accordingly, the drawings and detailed description are to be regarded as illustrative in nature and not restrictive.

### BRIEF DESCRIPTION OF THE DRAWINGS

FIG. 1A is a flowchart of a method for administering an insurance policy in accordance with embodiments of the invention that reimburses the policy holder for all or a portion of the cost of COBRA Coverage.

FIG. 1B is a flowchart of a method of reimbursing the policy holder for all or a portion of the cost of COBRA Coverage.

FIG. 1C is a flowchart of a method of providing an insurance product.

FIG. 2 is a flowchart of a method for administering individual/family health insurance in accordance with embodiments of the invention that reimburses the policy holder for all or a portion of the cost of the individual/family health insurance premium upon experiencing a triggering and/or qualifying event.

FIG. 3 is an exemplary computing system for implementing the insurance product described in the embodiments of FIGS. 1A-2.

FIG. 3A shows the input and output of an exemplary computing system for purchasing the insurance product described in the embodiments of FIGS. 1A-2.

FIG. 3B shows the input and output of an exemplary computing system for processing premium payments and disbursements.

FIG. 3C shows the input and output of an exemplary computing system for processing a notification of a qualifying event and processing a change in the insurance policy product data.

### DETAILED DESCRIPTION

The present invention is applicable to health insurance, trusts, health maintenance organizations, self-funded pay-as-you-go plans, reimbursement plans, life insurance, and variations and combinations thereof.

According to certain embodiments, an insurance product, e.g., a policy and/or rider, provides a policy holder or beneficiary electing COBRA Coverage with benefits that reimburse the policy holder or beneficiary for the costs of the COBRA Coverage. Various costs associated with the COBRA Coverage that may be offset by the insurance product of the present invention include: the entirety of the premium (for the COBRA Coverage), which includes the insured's contribution to the employer-sponsored plan group rate, and the insured's employer's contribution to the employer-sponsored group rate, and any administrative fee.

The various aspects of the present invention are described below with reference to the figures.

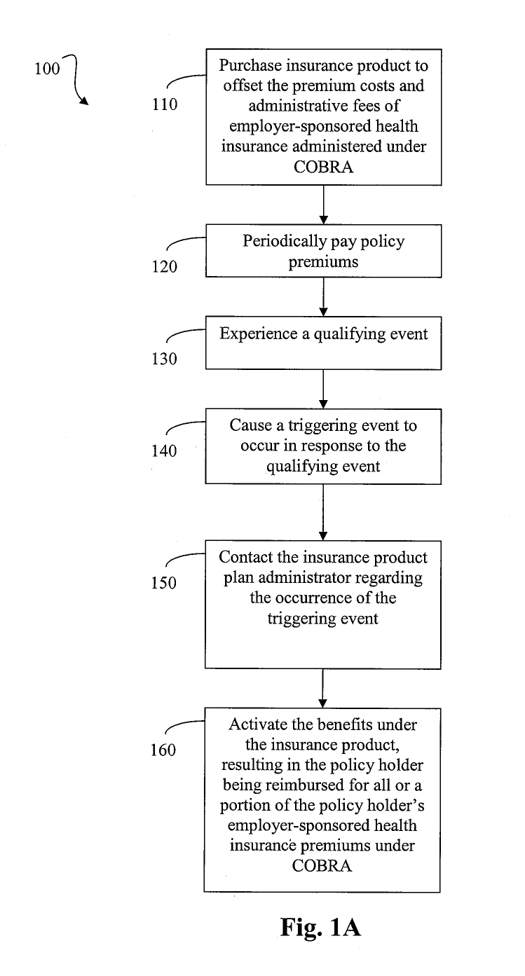

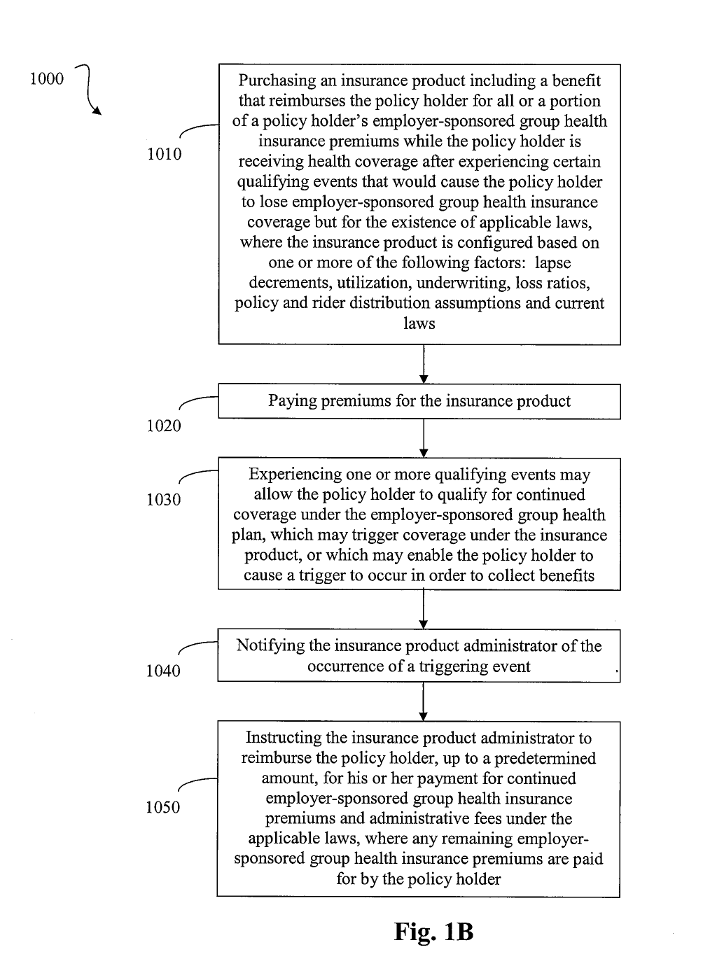

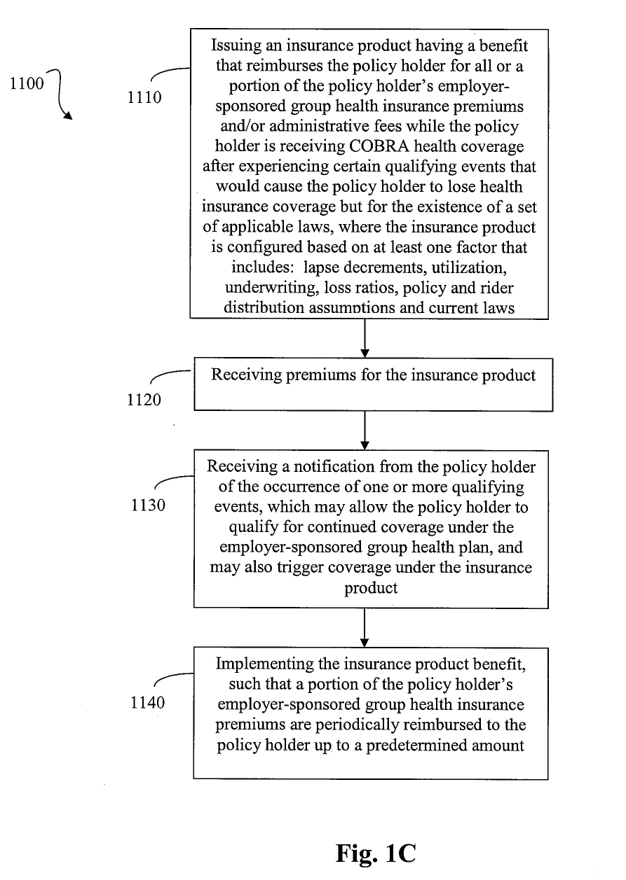

FIG. 1A is a flowchart of a method (100) for administering an insurance product, in accordance with embodiments of the invention. According to FIG. 1A, an insurance product is purchased (110) for the purpose of reimbursing a policy holder for all or a portion of the premium costs and administrative fees of employer-sponsored health insurance administered under COBRA. Premiums are periodically paid (120) under the insurance product, and upon experiencing (130) a qualifying event under COBRA, the policy holder causes a triggering event under the insurance product to occur (140), e.g., the policy holder elects to receive and pays for COBRA continued coverage as a result of the qualifying event. Once the policy holder causes the triggering event to occur (140), the policy holder may contact (150) the insurance product plan administrator regarding the occurrence of the triggering event, and the benefits under the insurance product are activated (160), resulting in the policy holder being reimbursed for all or a portion of the policy holder's employer-sponsored health insurance premiums under COBRA.

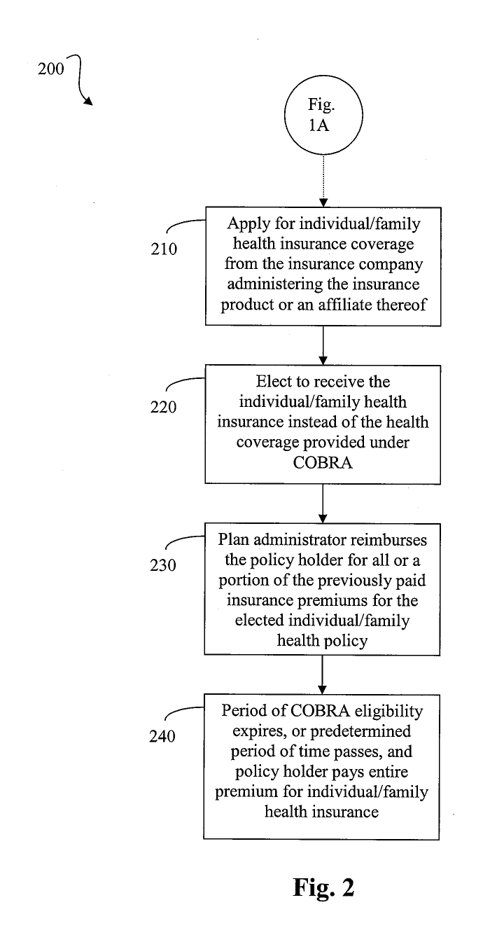

According to certain implementations, insurance products may be marketed and offered to individuals, and individuals may purchase (110) the insurance product anytime or periodically. As will be discussed further below, the insurance product may be configured based on one or more of the following factors: lapse decrements, utilization, underwriting, loss ratios, policy and rider distribution assumptions and current laws. The insurance product may be a stand alone product, or may be associated with a rider, discussed below in connection with FIG. 2. For example, the stand alone policy may be offered to employed individuals participating in their employer-sponsored group health plan. The benefit to be received under the policy may be selected by the individual at the time of application, and may be changed periodically, e.g., the benefits under the policy may be increased or reduced. In addition, individuals covered under the policy may be added or dropped at any point. For example, where a spouse enrolls in individual health insurance coverage, they may be dropped from the policy holder's policy, while the policy holder and dependents retain coverage under the policy. Furthermore, because the policy is sold to and owned by an individual policy holder, the insurance policy is portable and may be utilized anytime the policy holder is or was employed and participating in their employer-sponsored group health plan, and/or where group coverage changes and/or where benefits are reduced. Insurance products provided according to the present invention may be sold by health and/or life insurance companies, including insurance companies administering individual health plans and/or employer-sponsored group health plans.

Insurance premiums for the insurance product may be periodically paid (120) by the policy holder directly (e.g., by direct debit, credit card or check), or by automatically deducting the premiums from a policy holder's paycheck in a manner similar to the way employer-sponsored group health insurance premiums are deducted. While the policy holder is receiving benefits under the policy, e.g., receiving reimbursement for payment of COBRA Coverage the policy holder's requirement to pay premiums under the insurance product may be suspended.

The policy holder may experience (130) a qualifying event when he or she experiences an event that would cause he or she to lose health coverage under an employer-sponsored group health plan, but for the existence of COBRA or other applicable laws. Qualifying events may include: termination of employment of the employee participating in his or her employer's group health plan, reduction of the number of hours worked by the covered employee, an employee qualifying for Medicare, divorce from a covered employee, death of a covered employee, and/or loss of dependent child status.

Where a policy holder experiences (130) a qualifying event that qualifies the policy holder to receive COBRA continued coverage, the policy holder may cause a triggering event under the insurance product to occur (140). According to certain implementations, only certain qualifying events may allow the policy holder to cause the triggering event to occur (140). For example, experiencing (130) involuntary termination of employment may be the COBRA qualifying event that enables a policy holder to cause a triggering event under the insurance product to occur (140) under the policy. That is, involuntary termination may be the requisite qualifying event for activating the benefits under the insurance policy, whereas experiencing any other qualifying event would not enable the policy holder to cause a triggering event to occur. According to this example, a policy holder, having been involuntarily terminated from his or her employment, may cause a triggering event under the insurance product to occur (140) by, for example, electing to receive COBRA Coverage and paying for COBRA Coverage premiums. However, it will be understood that any one or more qualifying events under which an employee may elect and pay for COBRA Coverage may enable the policy holder to cause the triggering event under the insurance product to occur (140). Furthermore, a policy holder may cause a triggering event under the insurance product to occur (140) by engaging in other activities that are in addition to or an alternative to election of COBRA continued coverage and payment of COBRA health insurance premiums.

Once coverage under the insurance product is triggered, the policy holder may notify (150) the plan administrator of this occurrence. Notification (150) may include providing proof of the requisite qualifying event, e.g., proof of involuntary termination of the policy holder's employer-sponsored medical coverage, along with proof of the occurrence of a triggering event. Such proof may be in the form of written evidence showing the employer-sponsored medical coverage terminated and the policy holder is paying COBRA Coverage premiums. Written evidence may include claim forms, billing statements and/or payment receipts. Alternatively, where the insurance company receives premium payments (120) by automatic payroll deduction, and the automatic payments cease, the insurance company, instead of being notified (150) by the policy holder, may make an inquiry to the policy holder as to whether the payments ceased due to the policy holder experiencing a qualifying event under COBRA and/or whether a triggering event t under the insurance product has occurred. Where a triggering event under the insurance product has occurred, and in some implementations, verified, the benefits under the insurance policy may be activated (160).

Activated (160) benefits under the policy means that the insurance company may periodically reimburse the policy holder for COBRA premiums that he or she has paid, e.g., pay weekly, bi-weekly, monthly, quarterly, for a time period ending after the policy holder no longer participates in group health coverage under COBRA and/or after a predetermined time period, e.g., 18 to 36 months. The benefits paid to the policy holder may be for all or a portion of the COBRA Coverage premium or administrative fee under the policy. In addition, the policy holder may be required to show proof of premium payment periodically, e.g., monthly, before the insurance administrator continues to reimburse the policy holder.

In further implementations, the reimbursement benefit for a policy holder electing and paying for COBRA Coverage may be combined with additional benefits under the insurance policy. For example, the insurance policy for reimbursing the policy holder for the costs of health coverage administered under COBRA may be coupled with an accidental death benefit. In this implementation, if the policy holder experiences an accidental death, the policy holder's beneficiaries may be paid a predetermined benefit amount. Prerequisites for receiving the accidental death benefit may include that the accidental death occur within a predetermined amount of time from an injury, infection, drowning, or other triggering event, e.g., an event specified in the policy. The accidental death benefit may be paid in a lump sum or in a series of payments over a period of time.

According to certain implementations, the policy holder may be required to pay policy premiums for a predetermined period of time before the policy holder or his or her beneficiaries are allowed to receive benefits under the policy. For example, a policy holder may be required to pay premiums for a period of months or years in order to be eligible to receive full benefits under the policy. Where a policy holder applies for benefits under the policy before completing the initial premium pay-in period, the policy holder may have his or her benefits reduced, e.g., a reduction of benefits by 50%, or a prorated reduction in benefits depending on the amount of time the policy holder paid premiums. In instances where a policy holder increases their benefits, the policy holder may be required to pay premiums for the increased benefits for a predetermined period of time before becoming eligible to receive full benefits under the policy. Requiring the policy holder to pay premiums for a period of time before becoming eligible to receive full benefits may serve as a deterrent for people purchasing the policy that know they will become unemployed.

In another embodiment, the amount the insurer will reimburse the policy holder for his or her COBRA premium payments may be based on the amount of time the policy holder paid premiums under the policy before receiving policy benefits, and the full, maximum benefit may increase over time. For example, if a policy holder who experiences a triggering event has paid premiums under the insurance policy for one year, the plan benefits may reimburse the policy holder up to $200 per month for the policy holders payment of COBRA Coverage premiums; whereas if a policy holder who experiences a triggering event has paid premiums under the insurance policy for five years, the plan benefits may reimburse the policy holder up to $500 per month for the policy holder's payment of COBRA Coverage premiums.

In a further embodiment, the insurance policy for reimbursing the policy holder for the costs of health coverage administered under COBRA may be offered with a rider that would increase the amount of COBRA premiums for which the policy holder can be reimbursed by a predetermined or indexed percentage. In certain embodiments, the amount of increase may relate to the increased amount of premiums that the policy holder is willing to pay for the rider protection. An inflationary rider may be useful in instances where the premiums for policy holder's employer-sponsored, group health plan increase, resulting in an increase in the COBRA premium amount that the policy holder would be required to pay if a qualifying event occurred. By electing an inflationary rider, the policy holder may be given assurance that, even where COBRA premiums are increased, the inflationary component of the rider may cover all or a portion of the increased cost.

FIG. 1B is a flowchart of a method (1000) of reimbursing a policy holder for all or a portion of the premium costs and administrative fees of COBRA Coverage involving: purchasing (1010) an insurance product including a benefit that reimburses the policy holder for all or a portion of a policy holder's employer-sponsored group health insurance premiums while the policy holder is receiving health coverage after experiencing certain qualifying events that would cause the policy holder to lose employer-sponsored group health insurance coverage but for the existence of applicable laws, where the insurance product is configured based on one or more of the following factors: lapse decrements, utilization, underwriting, loss ratios, policy and rider distribution assumptions and current laws. Paying (1020) premiums for the insurance product maintains the availability of the benefits under the insurance product. Experiencing (1030) one or more qualifying events may allow the policy holder to qualify for continued coverage under the employer-sponsored group health plan, which may trigger coverage under the insurance product, or which may enable the policy holder to cause a trigger to occur in order to collect benefits under the insurance product. Upon the occurrence of a triggering event, the method (1000) involves notifying (1040) the insurance product administrator of the occurrence of a triggering event under the insurance product, and instructing (1050) the insurance product administrator to reimburse the policy holder for all or a portion (e.g., up to a predetermined amount) of the employer-sponsored group health insurance premiums and administrative fees under the applicable laws, where any remaining employer-sponsored group health insurance premiums beyond the predetermined amount are the responsibility of the policy holder. Accordingly, the receipt of the proof of payment of the COBRA Coverage premium from the policy holder enables the benefits under the insurance product to become active.

FIG. 1C is a flowchart of a method (1100) of providing an insurance product. According to FIG. 1C, the method (1100) includes issuing (1110) an insurance product including a benefit that reimburses the policy holder for all or a portion of the policy holder's employer-sponsored group health insurance premiums and/or administrative fees while the policy holder is receiving COBRA health coverage after experiencing certain qualifying events that would cause the policy holder to lose employer-sponsored group health insurance coverage but for the existence of a set of applicable laws, where the insurance product is configured based on one or more of the following factors: lapse decrements, utilization, underwriting, loss ratios, policy and rider distribution assumptions and current laws. Receiving premiums for the insurance product (1120) maintains an active insurance product. Receiving (1130) a notification from the policy holder of the occurrence of one or more qualifying events may allow the policy holder to qualify for continued coverage under the employer-sponsored group health plan, and may also trigger coverage under the insurance product. Upon the occurrence of a triggering event, the method involves implementing (1140) the insurance product benefit, such that a portion of the policy holder's employer-sponsored group health insurance premiums are periodically reimbursed to the policy holder up to a predetermined amount.

### Insurance Policy Individual Health Insurance Premium Reimbursement Rider

According to certain implementations, the insurance policy for reimbursing the policy holder for the costs of health coverage administered under COBRA may be offered with a rider that enables the policy holder to, instead of electing to receive COBRA Coverage, apply for and receive individual/family health insurance and have the insurer, under the benefits available under the policy, reimburse him or her for costs of the premiums for the other individual/family insurance product. The individual health insurance premium reimbursement rider would enable a policy holder to elect to receive individual/family health insurance upon qualifying (e.g., upon the occurrence of a qualifying or triggering event) and be reimbursed for all or a portion of the individual/family health insurance premiums for a predetermined period of time (e.g., 18 months).

FIG. 2 is a flowchart of a method (200) for administering individual/family insurance where the policy holder is reimbursed for all or a portion of the costs of health insurance, according to certain embodiments. Method 200 may proceed concurrently with or intervene with method 100 so that when the policy holder experiences a qualifying event (130), e.g., the policy holder is involuntarily terminated from his or her employment, and/or causes a triggering event to occur (140), e.g., the policy holder elects to receive COBRA Coverage and/or applies for and qualifies for health insurance from the health insurance company administering the policy/rider, method 200 may be initiated. According to FIG. 2, a policy holder having purchased a rider for individual health insurance premium reimbursement, may apply. (210) for individual/family health insurance coverage from the insurance company administering the insurance product or an affiliate thereof. If the policy holder is accepted for coverage, the policy holder may elect (220) to receive the individual/family health insurance instead of the health coverage provided under COBRA. The plan administrator continues to provide benefits under the insurance product and reimburses (230) the policy holder for all or a portion of the previously paid insurance premiums for the elected individual/family health policy. After a period of time, which may correspond to the period of COBRA eligibility had the policy holder elected to stay covered under the COBRA Coverage, or which may correspond to another predetermined period of time, the plan administrator ceases to reimburse the policy holder for all or a portion of the premium, and instead, the policy holder is responsible to pay (240) the entire premium to maintain their individual/family health plan.

According to certain embodiments, the policy holder and beneficiaries of the employer-sponsored group health plan may apply together or separately to qualify (210) for the individual health insurance coverage, or the coverage may be made available solely to the policy holder and not independently to the policy holder's beneficiaries under the employer-sponsored group health plan. The policy holder and/or beneficiaries may apply for health insurance at the time of purchasing the individual health insurance premium reimbursement rider, or the application may be completed when a policy holder experiences a qualifying event (130) or causes a triggering event (140) to occur. The insurance company may provide the policy holder with individual/family health plan options having benefits that are similar to the benefits provided under the employer-sponsored group health plan, and/or may provide individual/family health plan options according to the policy holder's preferences, e.g., a plan with premiums below a certain dollar amount and/or a plan with a higher or lower deductible.

Giving the policy holder the option to apply for individual/family health insurance provides advantages to the policy holder. Instead of losing health insurance coverage after the period of COBRA eligibility expires, a policy holder enrolled in an individual/family health policy keeps his or her health insurance. In such a case, the policy holder and his or her beneficiaries may receive the cost benefit of the insurance product for the term of COBRA eligibility (e.g., premiums lowered by $500 per month for 18 months) and after the term of the insurance product expires, the policy holder has the added advantage of keeping his or her health insurance benefits. Subsequent premiums owed will be the responsibility of the policy holder, and the insurance product may no longer reimburse the policy holder for the cost of the individual/family health insurance issued by the insurance company or its affiliate.

According to further implementations, where a policy holder applies for individual health insurance and is not issued a policy, the insurance company may refund the cost of the individual health insurance premium reimbursement rider to the policy holder.

### Insurance Product Pricing and Configuration

In offering an insurance product for reimbursing the policy holder for the costs of COBRA continued coverage, with or without the individual health insurance premium reimbursement rider, or other riders, the product must be commercially viable so that it is attractive to a consumer, but profitable for the insurance company. The insurance product's design is a major factor in its viability, and several complexities are involved. For example, product configuration and pricing involves consideration of lapse decrements, utilization, underwriting, loss ratios, policy and rider distribution assumptions and current laws. Some prior art suggests COBRA insurance policies, but none address complexities such as these.

Lapse decrement components associated with pricing and plan configuration, according to certain embodiments, may include: expected number of lapsing policy holders (e.g. due to non-payment or electing to drop coverage), which results in a decreased collection of premiums; the expected employee termination rates (voluntary and involuntary), including the expected number of involuntarily terminated policy holders, along with the expected number of those involuntarily terminated that elect to receive COBRA and benefits under the insurance product, which results in an increased amount of paid benefits and a decreased collection of premiums; and the anticipated average length of time of benefit utilization.

Utilization rates may be associated with plan configuration and pricing. For example, lapse rates of policy holders that have exercised their benefits under the insurance product is one aspect of utilization that may be considered in plan configuration and pricing. For example, 20% of policy holders exercising their benefits may be expected to cease their benefit utilization after one or two months. From the third through the fourteenth consecutive benefit month, benefit utilization may be expected to drop at a rate of 5% per month. For each of the 15^{th}, 16^{th} and 17^{th} consecutive benefit months, benefit utilization may drop at a rate of 20%, and at the 18^{th} consecutive benefit month, or the maximum amount of time benefits may be utilized, 100% of those previously utilizing benefits are no longer eligible to receive benefits. Where a policy holder has purchased an optional individual health insurance premium reimbursement rider, lapse rates may differ and benefit utilization may drop at a rate of 5% per month for the first 16 consecutive benefit months. At the 17^{th} benefit month, the utilization reduction may be expected to rise to 20% over the prior month, and at the 18^{th} benefit month, or the maximum amount of time benefits may be utilized, the benefit utilization rate will drop by 100%.

Underwriting, or the absence thereof, may be factored into plan pricing and configuration. According to certain embodiments, the insurance policy and rider may be guaranteed to issue where the policy holder is enrolled in employer sponsored group coverage and would be eligible to continue the COBRA Coverage for a period of time upon termination of employment. Alternatively, a policy holder and/or family members may be required to undergo an underwriting process to be qualified under the insurance policy and/or rider.

Loss ratios for the duration of the policy may also be considered. For example, from year to year, the loss ratio of the insurance product is expected to increase, and over the lifetime of the insurance product, the overall loss ratio may exceed 50%. Additionally, plan distribution assumptions based on plan type (e.g., a number of plans having differing monthly insurance replacement benefit amounts) and an expected percentage of policy holders that elect to purchase the rider or riders, may also factor into policy pricing and configuration. Another factor associated with the policy configuration is the assumption that laws and regulations that govern the insurance product of the present invention will not change over the lifetime of the policy.

The insurance policies of the present invention may be configured based on the aforementioned factors as well as others. For example, statistical information, such as U.S. Department of Labor statistics, may be used in deciding who may be eligible to receive benefits under the policy, e.g., involuntarily and/or voluntarily terminated individuals, and what requirements need to be met in order to receive benefits under the policy. In addition, where an insurance product includes an accidental death benefit, mortality data, e.g., publicly available data and proprietary data, may be used so the pricing of the product takes into consideration, for example, accident rates by age and the assumed accident-related mortality per group of policy holders for a target age group, e.g., individuals between 35 and 60.

Risk associated with the population targeted for the product may be a pricing and policy configuration factor. For example, by targeting populations that are participating in employer-sponsored group health care in a relatively stable industry, the product may be sold not in response to a life-changing event, but rather is sold in case an employee incurs such an event, and thus the risk of utilization by policy holders in the less volatile industry may be lower resulting in lowered premiums. In addition, policy requirements such as a pay-in period before policy holders become eligible for full benefits may be taken into account.

In addition, the configuration of the policy, such as the manner in which policy benefits are administered, may be taken into account for pricing and vice versa. For example, because the present invention is configured so that individual policy holders are reimbursed directly for their COBRA premium payments, rather than having the payments settled directly between the COBRA insurance administrator and the insurer, administrative costs associated with tracking COBRA premiums, premium changes, use and utilization changes, which otherwise could be passed onto the policy holder, are not passed onto the policy holder.

Insurance policies that reimburse the policy holder for the costs of health coverage administered under COBRA according to implementations of the present invention may provide certain advantages. For example, according to certain embodiments, because policy holders are reimbursed for their payment of COBRA premiums to their plan administrator, as opposed to the insurance company paying COBRA premiums to a plan administrator, administrative costs and complexities associated with paying the health insurance company are eliminated. One complexity avoided involves tracking COBRA premiums amounts for each policy holder receiving benefits, which may be difficult because COBRA premiums are subject to change during a policy holder's time of coverage. Another complexity avoided involves tracking which individuals are receiving COBRA continued coverage. Thus, a policy holder may add or drop dependents from their COBRA continued coverage while receiving benefit under the policy, and the insurance company reimburses the policy holder up to the full benefit regardless of who is receiving the COBRA continued coverage. In addition, by paying the policy holder directly on a lump sum, periodic basis, e.g., $500 per month, the policy holder may pay for other expenses that arise while unemployed. Furthermore, where the policy holder becomes re-employed and is offered employer-sponsored coverage, the policy holder may continue to receive benefits under the policy as long as the policy holder pays the COBRA Coverage premiums.

In one embodiment, the above-discussed factors are combined with assumptions on expected behavior of the population of policy holders. In this embodiment, of a population of 1000 policy holders, in each month of the duration of the policy, 2% may be expected to allow their policy to lapse, 2.5% may be expected to leave their employment, a portion of which is voluntary and the other portion involuntary. Of those voluntarily leaving their employment, a percentage of the policy holders are expected to continue paying premiums, and of those terminated involuntarily, a percentage is expected to exercise plan benefits. According to these assumptions, information about the number of policies in force after 1 year, and the number of policy holders exercising benefits may be calculated. As a result, after one year, the cumulative loss ratio, e.g., the paid and incurred claim amount as a percentage of annual premiums collected, may be calculated, and over the lifetime of the product, e.g., after a five year term, the cumulative loss ratio may be calculated. Based on these assumptions, a COBRA continued coverage insurance product may be offered.

Aspects of the present invention protect an employee and his or her family against the loss of affordable health insurance by providing an insurance plan that will reimburse the policy holder for all or a portion of the COBRA Coverage premiums. This may provide advantages to an employee/former employee, their family, and to the health insurance industry. Employees and their families benefit by receiving affordable health insurance during a period of time when additional expenses would not be easily paid for. The insurance industry benefits because individuals that have health insurance may be more likely to be proactive with their health and take preventative measures in order to avoid potentially life threatening conditions which are costly for the individual and the insurance company.

According to certain implementations, a beneficiary or representative may, in addition or as an alternative to the policy holder, engage the methods provided in accordance with the present invention. Beneficiaries may be individuals participating in a group health plan on the day before a qualifying event and may include spouses and/or dependent children, siblings, parents, and children born to or placed for adoption with a covered employee during the period of eligibility. Representatives may include family members, guardians or court appointed representatives.

Although the present invention has been described in the context of providing relief to policy holders insured under COBRA Coverage, other policy holder insured according to other laws or otherwise are contemplated. For example, laws similar to COBRA apply to the Federal government, and aspects of the present invention may be applicable to continued coverage provided to Federal employees and their spouses or dependents upon experiencing a qualifying event. Under certain circumstances, COBRA and COBRA-like coverage is unavailable. For example, employees of church-affiliated organizations or of companies having twenty or less employees are not subject to COBRA provisions. Accordingly, where employees participate in an employer's group health plan that is not subject to COBRA provisions, certain implementations of the present invention may provide beneficiaries with insurance alternatives that, if elected, may have the cost offset for a predetermined period of time.

The methods and systems of the present invention may utilize various combinations of software and hardware, as would be apparent to those of skill in the art and as desired by the user. In addition, the present invention may be implemented in conjunction with a general purpose or dedicated computer system having a processor and memory components.

### Computer System Implementation

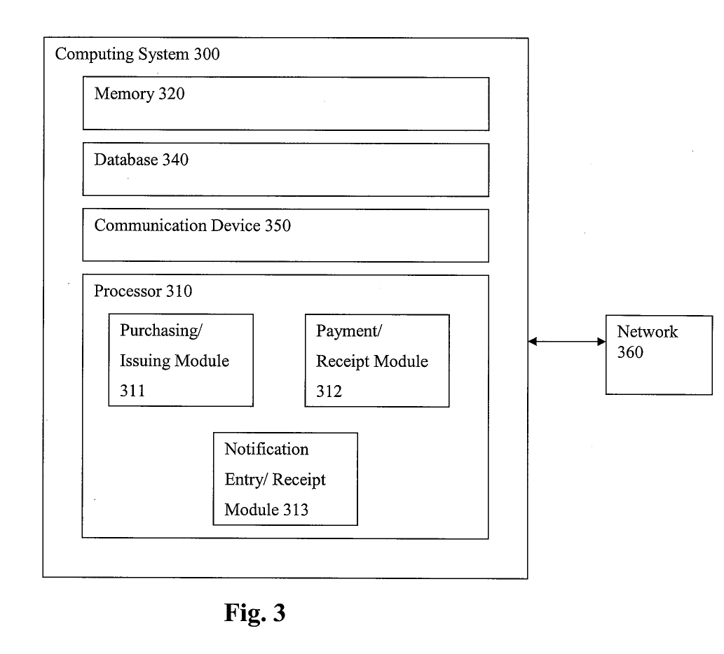

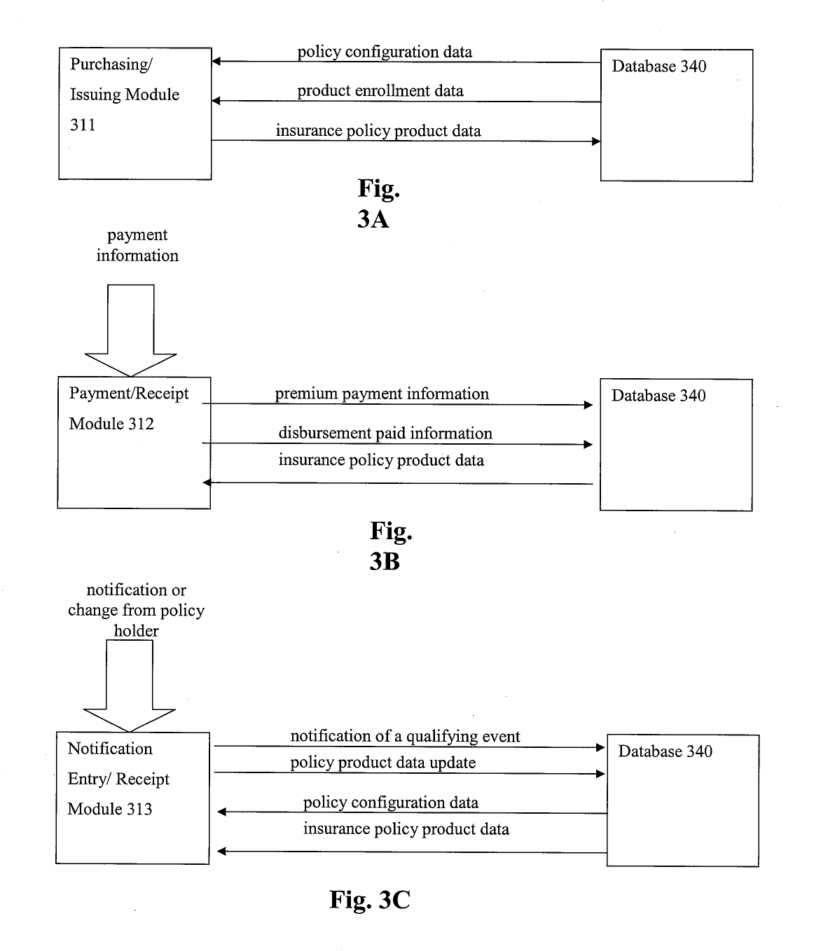

FIGS. 3, 3a., 3b., and 3c. all describe exemplary computing systems for implementing the insurance product described in the embodiments of FIGS. 1A-2. The insurance product may be managed through a computing system 300. Modules 311,312 and 313 are computer programs running on a computer processor 310. The modules may be part of the same computer program, or be separate programs. The modules include a means of communication between themselves and a means of communication between the modules and individual persons and policy holders, whether directly, such as through a webpage, or through an intermediary such as an insurance agent who enters the information into the computer system 300.

The database module 340 is configured to store and retrieve information associated with the insurance policy and the configuration of the insurance policy such as, but not limited to policy configuration data, product enrollment data, insurance product policy configuration data and any other data necessary for the administration and issuance of the policy described in this specification. The term database is well understood in the art to mean any structured collection of records stored in a computer system.

FIG. 3a illustrates the generation of the policy. When an individual wishes to purchase a policy, the individual submits product enrollment information which is stored in database 340. The product enrollment information may include, but is not limited to, individual demographic information of the prospective policy holder, desired coverage rates, and desired riders. The purchasing/issuing module 311 retrieves this data, along with the pre-stored policy configuration data. The policy configuration data may include, but is not limited to, lapse decrements, utilization, underwriting, loss ratios, policy and rider distribution assumptions and current laws. The purchasing/issuing module 311 then generates the insurance policy product data which defines the terms of the policy. The insurance policy product data defines terms associated with an insurance policy for providing coverage to the individual and may include, but is not limited to, policy holder name, address, age, or other policy holder characteristics, policy details such as premium amount, benefit amount and duration, the existence of any of the optional riders, data indicating claims authorized and paid, and any notifications of qualifying or triggering events, and payments made or due. This policy data is then stored by the database 340.

FIG. 3b illustrates the process of updating payment and disbursement information stored in the policy product data. Once payment is received, either electronically, or manually, the information regarding the payment is sent to the payment/receipt module 312 which retrieves and updates the payment information stored in the policy product data in the database 340.

When a policy holder files a claim for reimbursement, the payment/receipt module 312 is notified, either electronically or manually. The payment/receipt module 312 then checks the policy product data to determine whether the reimbursement is allowed and if so, updates the disbursement information stored in the policy product data in the database 340. Some embodiments would also have the payment/receipt module 312 automatically issuing a check or making a direct deposit into the policy holder's bank account. Other embodiments would have the payment/receipt module simply generating a report or sending a message to another system or a person to issue an actual check or payment.

FIG. 3c illustrates the processing of a notification of a qualifying event, and a modification of policy details (such as premium amount, what constitutions a qualifying event, addition or removal of a rider, etc.). Module 313 receives a notification of a qualifying event from a policy holder either directly, such as through a webpage, or through an intermediary such as an insurance agent who enters the information into the computer system 300. The module then updates the database 340 to update the policy configuration data to reflect receipt of this notification. In one embodiment the computer system automatically attempts to verify the existence of a qualifying event.

The notification entry/receipt module also processes changes that the policy holder might need to make to the policy details. Such changes would be as simple as an address change, to more complex changes such as addition or removal of coverage. The notification entry/receipt module receives a notice of the change from the policy holder either directly, such as through a webpage, or through an intermediary such as an insurance agent who enters information into the computer system 300. The notification entry/receipt module then retrieves both the policy product data and the policy configuration data and ensures that the desired changes to the policy product data are compatible with the parameters in the policy configuration data. If the changes are compatible, the notification entry/receipt module updates the policy product data in the database.

Nothing in the specification should be read to limit the operation of this system to a single computer or computer system, but for clarity one computer is shown and demonstrated. Indeed the functions described could be spread across a computer network.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A computer-implemented system for generating insurance policy product data associated with an insurance policy providing insurance coverage for at least one individual, comprising
a computer processor programmed to:
retrieve policy configuration data from an electronic database comprising at least one of the following configuration factors: lapse decrements, utilization, underwriting, loss ratios, policy and rider distribution assumptions and current laws;
retrieve product enrollment data for an individual to be insured from an electronic database; and
generate insurance policy product data based on the product enrollment data and the policy configuration data wherein the insurance policy product data defines terms associated with an insurance policy for providing insurance coverage to the individual, wherein the insurance policy defines a reimbursement benefit that reimburses the individual for at least a portion of the individual's health insurance premiums while the individual is receiving health coverage after occurrence of a qualifying event; and
an electronic database for storing the insurance policy product data, individual product enrollment data and policy configuration data.

2. The system of claim 1, wherein the individual's insurance policy is employer-sponsored group health policy.

3. The system of claim 1, wherein the qualifying event is termination of the individual's employment.

4. The system of claim 1, wherein the reimbursement benefit defined by the insurance policy product data reimburses at least a portion of premiums incurred by the individual under a new health insurance policy purchased after occurrence of the qualifying event.

5. The system of claim 1, wherein the insurance policy product data further defines an accidental death benefit that pays a predetermined amount upon accidental death of the individual.

6. The system of claim 1, wherein the insurance policy product data further defines an inflationary benefit that increases the amount of premiums and administrative fees for which the individual can be reimbursed over time.

7. A computer-implemented method for generating insurance policy product data associated with an insurance policy providing insurance coverage for at least one individual, comprising:
retrieving policy configuration data from an electronic database comprising at least one of the following configuration factors: lapse decrements, utilization, underwriting, loss ratios, policy and rider distribution assumptions and current laws, wherein the retrieving is performed by a computer processor;
retrieving product enrollment data for an individual to be insured from an electronic database, wherein the retrieving is performed by the computer processor;
generating insurance policy product data based on the product enrollment data and the policy configuration data wherein the insurance policy product data defines terms associated with an insurance policy for providing insurance coverage to the individual, wherein the insurance policy defines a reimbursement benefit that reimburses the individual for at least a portion of the individual's health insurance premiums while the individual is receiving health coverage after occurrence of a qualifying event, wherein the generating is performed by the computer processor; and
storing the insurance policy product data, individual product enrollment data and policy configuration data in an electronic database.

8. The method of claim 7, wherein the individual's health coverage is employer-sponsored group health coverage.

9. The method of claim 7, wherein the qualifying event is termination of the individual's employment.

10. The method of claim 7, wherein the reimbursement benefit defined by the insurance policy product data reimburses at least a portion of premiums incurred by the individual under a new health insurance policy purchased after occurrence of the qualifying event.

11. The method of claim 7, wherein the insurance policy product data further defines an accidental death benefit that pays a predetermined amount upon accidental death of the individual.

12. The method of claim 7, wherein the insurance policy product data further defines an inflationary benefit that increases the amount of premiums and administrative fees for which the individual can be reimbursed over time.

13. The method of claim 7, wherein the computer processor is further programmed to:
update payment information in the insurance policy product data in response to a receipt of a premium payment;
update the insurance policy product data to reflect receipt of a notification of the occurrence of the qualifying event;
update the insurance policy product data in the database to reflect changes in the insurance policy; and
generate periodic reimbursement data for the individual upon receipt of notice of the occurrence of the qualifying event.

14. The method of claim 13, wherein the computer processor further is programmed to automatically deduct the premium payment from a bank account designated by the individual.

15. The method of claim 13, wherein the computer processor further is programmed to update the insurance policy product data to reflect receipt of a notification of the occurrence of the qualifying event upon cessation of automatic payments.

16. The method of claim 7, wherein the qualifying event comprises an event that would cause the individual to lose health coverage but for the existence of an applicable law.

17. The method of claim 16, wherein the applicable law is COBRA.

18. The method of claim 13, wherein the computer processor is further programmed to verify the occurrence of the qualifying event.

19. The method of claim 13, wherein the computer processor is further programmed to issue periodic reimbursement only during a period of eligibility as defined by applicable law.

20. The method of claim 13, wherein the computer processor is further programmed to cease periodic reimbursement at a predetermined time defined in the insurance product policy data.
